(19) United States
(12) Patent Application Publication
(10) Pub. No.: US 2007/0273500 A1
(43) Pub. Date: Nov. 29, 2007

(54) RADIO-LINKED STREETLAMP

(76) Inventor: Chih Hung Chiu, Jhongli City (TW)

Correspondence Address: LEONG C LEI, PMB # 1008, 1867 YGNACIO VALLEY ROAD, WALNUT CREEK, CA, 94598, US

(21) Appl. No.: 11/419,509

(22) Filed: May 22, 2006

(51) Int. Cl. G08B 19/00; F21V 23/04; G08B 13/00; G08B 17/12

(52) U.S. Cl. 340/522; 340/541; 362/276; 340/600

(57) ABSTRACT

A streetlamp according to the present invention will be turned on under two conditions: (1) when there is insufficient lighting determined by a light sensing system; and (2) when a motion detection system has sensed some disturbance within its coverage range or when a radio reception system has received a radio-frequency signal from a neighboring streetlamp. An illuminating streetlamp will automatically turn itself off after a period of time and if any one of the two conditions is not satisfied.

### BACKGROUND OF THE INVENTION

(a) Technical Field of the Invention

The present invention generally relates to streetlamps, and more particularly to a streetlamp capable of motion detection and light sensing to turn on neighboring streetlamps by radio signals.

(b) Description of the Prior Art

Providing sufficient illumination in public areas and along the roads during the night is the basic requirement for personal and traffic safety. However, the power consumption of streetlamps could be significant. For example, if a streetlamp consumes 1200 W, a hundred streetlamps would consume 120,000 W. If hundreds of streetlamps are turned on all night long (i.e., from 7 PM to 7 AM for twelve hours), the power consumption is staggeringly high. Considering that the energy cost increases in an exponential rate in recent years, a more efficient and energy-saving approach has to be developed to replace the conventional illumination approach based on always-on streetlamps.

### SUMMARY OF THE INVENTION

The primary purpose of the present invention is to provide a “smart” streetlamp to strike a balance between safety concerns and energy saving, which is radio-linked to neighboring streetlamps.

The principle behind the present invention lies in the idea that the streetlamps are not turned on unless it is necessary so as to achieve significant energy saving. To determine when is necessary to turn on a streetlamp of the present invention, the streetlamp contains a light sensing system which continuously monitors the lighting condition in its vicinity and a motion detection system which is capable of detecting activities and movements occurring with a 360-degree coverage range. The light sensing system is always functional while the motion detection system is activated and deactivated by the light sensing system. When the light sensing system determines that there is insufficient lighting in the surrounding (e.g., during night time, or when there is a thunderstorm, or when the streetlamp is positioned in a dark alley), the motion detection system is automatically activated. On the other hand, if there is sufficient lighting, the motion detection system will be automatically deactivated. When the motion detection system is activated and if some object moving inside or into the system's coverage range, the motion detection system will turn on the illuminating units of the streetlamp.

As a single streetlamp has a limited light coverage, to enhance the safety level, the streetlamp of the present invention has radio transmission and reception systems to transmit and receive wireless radio-frequency signals to and from the neighboring streetlamps in a 360-degree radio coverage range. When a streetlamp is turned on by the motion detection system, the streetlamp will automatically turn on all streetlamps within the radio coverage range, thereby producing a larger light coverage.

Accordingly, a streetlamp according to the present invention will be turned on under two conditions: (1) there is insufficient lighting determined by the light sensing system; and (2) the motion detection system has sensed some disturbance within its coverage range or the radio reception system has received the radio signal from a neighboring streetlamp. An illuminating streetlamp will automatically turn itself off after a period of time and if any one of the two conditions is not satisfied.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a streetlamp according to an embodiment of the present invention.

FIG. 2 is a profile diagram showing the streetlamp of FIG. 1.

FIG. 3 is an application scenario of the present invention where a number of streetlamps are disposed along a roadside.

FIG. 4 is a schematic diagram showing the relationship among various components of the present invention.

FIG. 5 is a schematic diagram showing the interaction among neighboring streetlamps.

FIG. 6 is a perspective diagram showing a streetlamp according to another embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

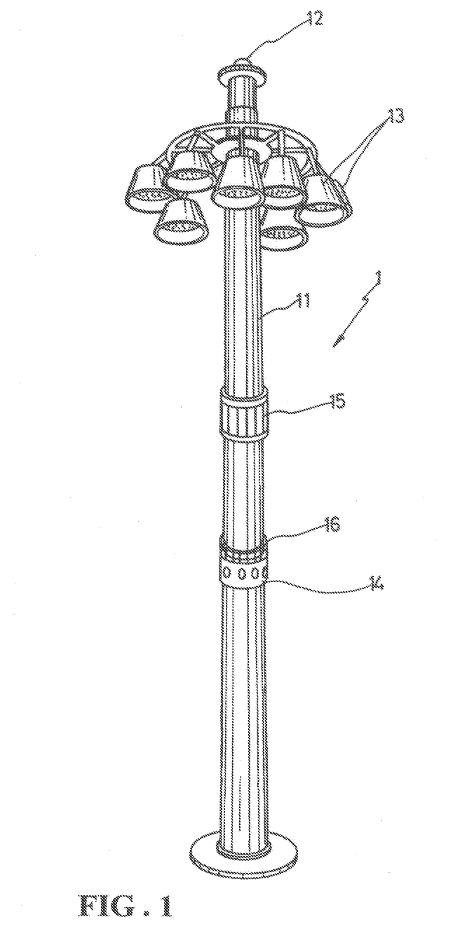

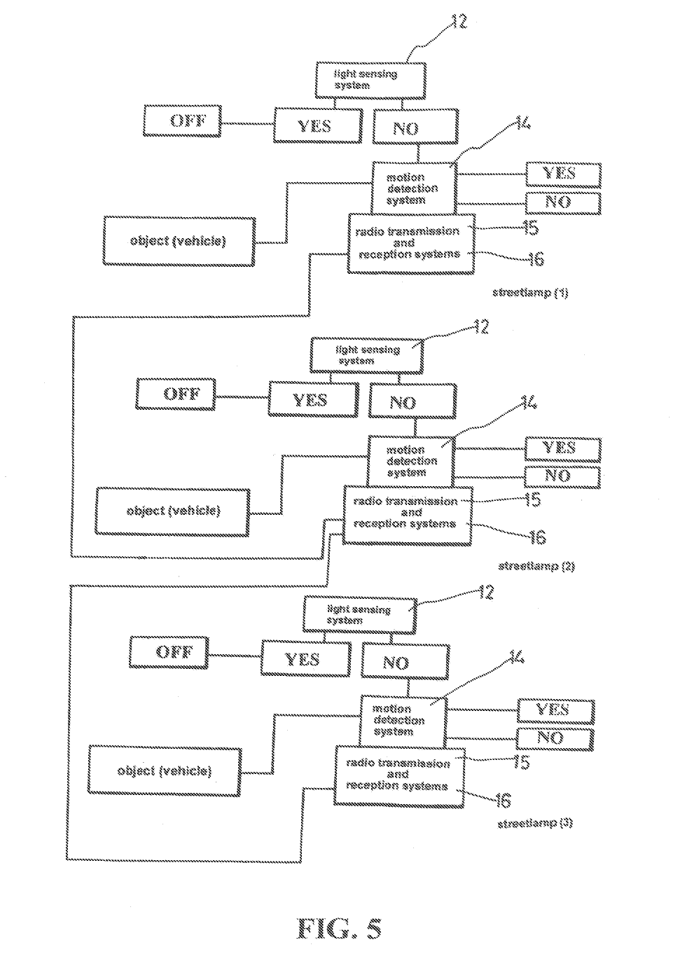

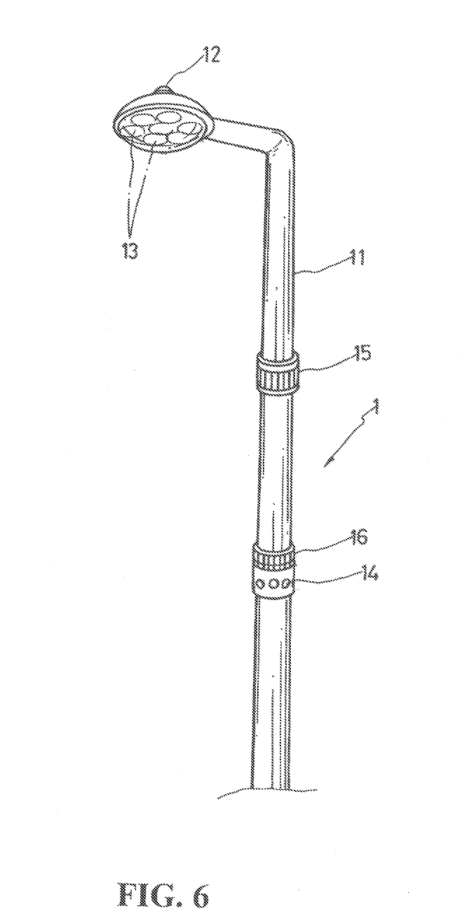

As shown in FIGS. 1 and 6, a streetlamp 1 according to the present invention mainly contains a lamp post 11, a light sensing system 12, one or more illuminating units 13, a motion detection system 14, a radio transmission system 15, and a radio reception system 16. The light sensing system 12 is positioned at a topmost location of the lamp post 11 so that its measurement of the lighting condition in its vicinity is less likely affected by surrounding objects. The light sensing system is always functional and the measurement obtained by the light sensing system 12 is continuously or periodically compared against a setting of the light sensing system 12. If the measurement of the lighting condition is higher than the setting (i.e., a “YES” condition of FIG. 5), implying there is sufficient lighting in the vicinity of the streetlamp 1, the motion detection system 14 remains in its idle state. On the other hand, if the measurement is lower than the setting (i.e., a “NO” condition of FIG. 5), implying there is insufficient lighting in the vicinity of the streetlamp 1, the motion detection system 14 is activated into a ready state and begins to monitor for any movement or activity occurred within the coverage of the motion detection system 14. As will be explained in more details, the streetlamp 1 will be turned on only after the light sensing system 12 has decided that there is insufficient lighting. On the other hand, a lighted streetlamp 1 will be turned off automatically whenever the light sensing system 12 decides there is sufficient lighting in its vicinity.

One or more illuminating units 13 are provided around the top end of the lamp post 11. The illuminating units 13 are highly projective and high-brightness lamps such as halogen lamps or high-brightness LED-based lamps. After the light sensing system 12 has decided that there is insufficient lighting in its vicinity, the lighting up of the illuminating units 13 is triggered by the motion detection system 14 or by the radio reception system 16.

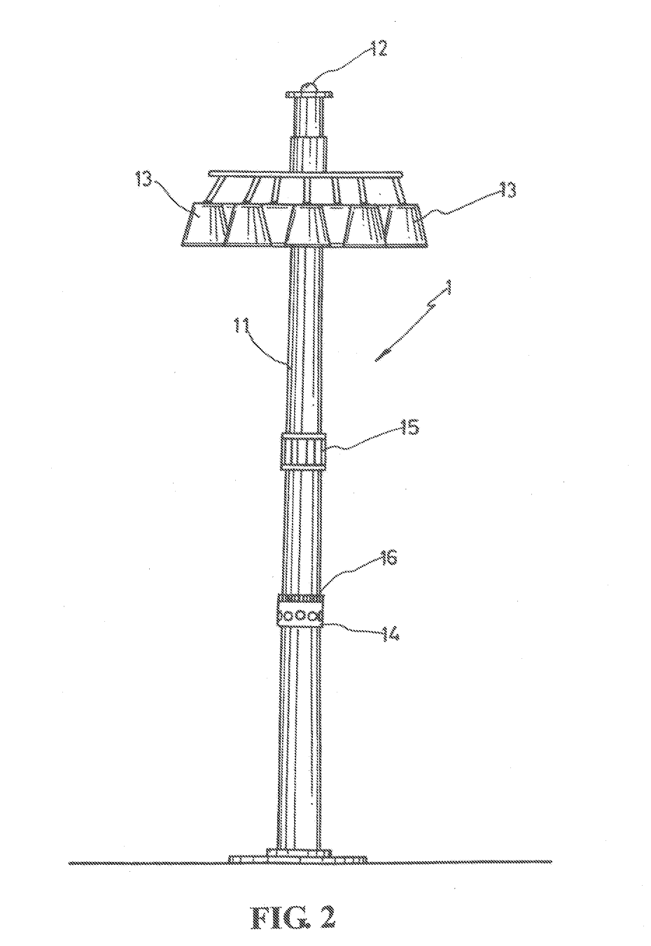

The motion detection system 14 can be housed inside the lamp post 11 or installed to the outside of the lamp post 11 as shown in FIG. 2. The motion detection system 14 has an omnidirectional (i.e., 360-degree) coverage range around the lamp post 11, whose monitoring process is enabled and disabled by the light sensing system 12 as described earlier. When the motion detection system 14 is enabled and some object is moving inside or into the coverage range of the motion detection system 14, the motion detection system 14, in addition to turning on its own illuminating units 13, triggers the radio transmission system 15 to transmit a radio-frequency wireless signal. The radio reception system 16 of every streetlamp 1 within the radio coverage range detects this wireless signal and turn on the respective illuminating units 13 as well. The radio transmission system 15 and the radio reception system 16 can be housed inside the lamp post 11 or installed to the outside of the lamp post 11. The radio transmission system 15 also has an omnidirectional radio coverage range. And there should be one or more streetlamps 1 positioned within the radio coverage range of any streetlamp 1. Please note that, in alternative embodiments, the coverage ranges of the monition detection system and the radio transmission system can be directional and can cover a specific area.

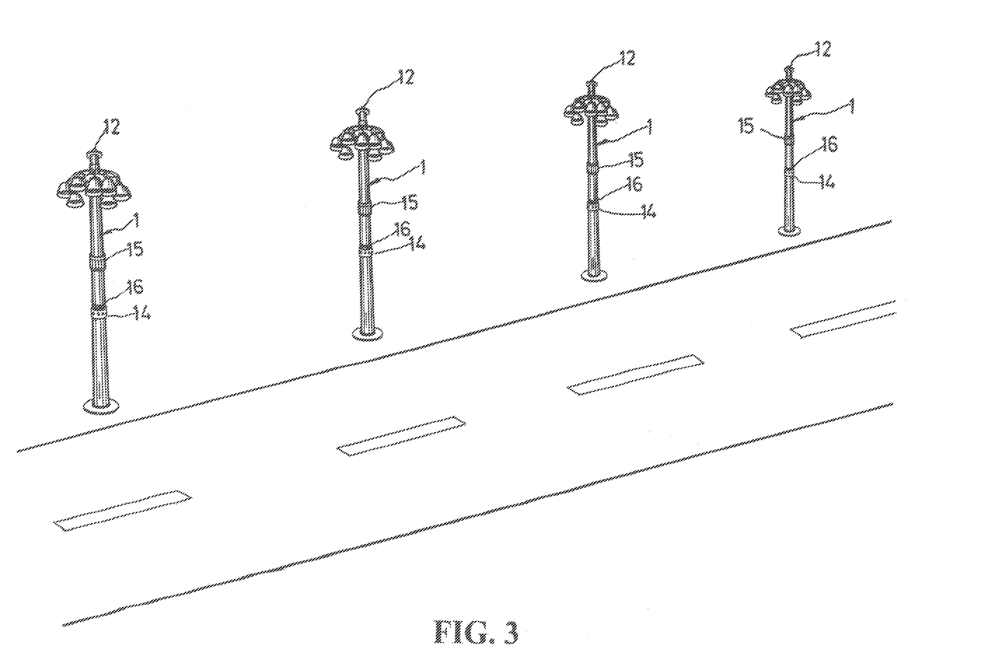

In an application scenario as shown in FIG. 3, the streetlamps 1 are positioned sequentially along the roadside. The light sensing system 12 of each streetlamp 1 continuously measures the lighting condition in its respective vicinity. After the sun sets or when there is no sufficient lighting, the motion detection system 14 of each streetlamp 1 is activated by the light sensing system 12. When a vehicle or a passenger enters the coverage range of any one of the streetlamps' motion detection systems 14, a number of neighboring streetlamps 1 will be turned on simultaneously as described above. As the vehicle or passenger moves along the road, successive groups of streetlamps 1 will be turned on sequentially like chain reaction (as illustrated in FIG. 5), always providing ample lighting to cover the vehicle or passenger.

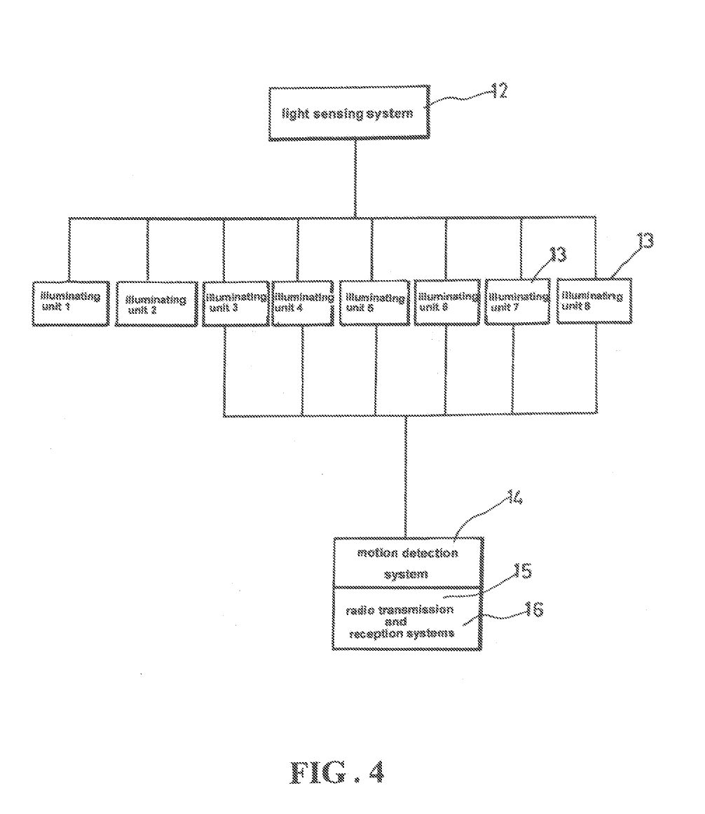

As shown in FIG. 4, a subset of the illuminating units 13 of a streetlamp 1 is connected to and controlled by the light sensing system 12 while the rest of the illuminating units 13 are connected to and controlled by both the light sensing system 12 and the motion detection system 14. As such, the subset of the illuminating units 13 will be turned on (or off) whenever there is insufficient (or sufficient) lighting regardless of the activity or movement occurring in their neighborhood so as to provide some minimum degree of illumination for safety reason.

As described, the streetlamp 1 according to the present invention will be turned on under two conditions: (1) when there is insufficient lighting determined by the light sensing system 12; and (2) when the motion detection system 14 has sensed some disturbance within its coverage range or the radio reception system 16 has received the radio-frequency signal from a neighboring streetlamp 1. An illuminating streetlamp will automatically turn itself off after a period of time and if any one of the two conditions is not satisfied.

The present invention provides a number of advantages over the prior arts. Firstly, the present invention requires only the easy assembly of a few components for a significant reduction of cost. Secondly, the position and angle of the screen member can be flexibly and conveniently adjusted in three degrees of freedom. The screen member can be “folded” so as to occupy minimum space when not in use. In addition, the beam member can be cut to fit on armrests of various sizes.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A streetlamp comprising a lamp post, at least a illuminating unit, a light sensing system, a motion detection system, a radio transmission system, and a radio reception system, wherein
said light sensing system positioned at a top location of said lamp post continuously measure a lighting condition in the vicinity of said streetlamp and activates and deactivates said motion detection system when said lighting condition is below and above a setting of said light sensing system;
said motion detection system, once activated, detects movement and activities occurring within a coverage range of said motion detection system, turns on said illuminating units when a disturbance is sensed, and triggers said radio transmission system to transmit a radio-frequency wireless signal;
said radio transmission system transmits said radio-frequency wireless signal to a coverage range of said radio transmission system;
said radio reception system, after receiving said radio-frequency wireless signal, turns on said illuminating units;
said illuminating units positioned at a top location of said lamp post are turned on under two conditions: (1) when there is insufficient lighting determined by said light sensing system; and (2) when said motion detection system has sensed some disturbance or said radio reception system has received said radio-frequency wireless signal from a neighboring streetlamp.

2. The streetlamp according to claim 1, wherein each of said motion detection system, said radio transmission and reception systems is installed inside or outside of said lamp post.

3. The streetlamp according to claim 1, wherein each of said coverage range of said motion detection system and said coverage range of said radio transmission system is omnidirectional.

4. The streetlamp according to claim 1, wherein at least one said streetlamp is positioned inside said coverage range of said radio transmission system.

5. The streetlamp according to claim 1, further comprising at least an additional illuminating unit which is turned on whenever there is insufficient lighting determined by said light sensing system.
